(19) United States
(12) Patent Application Publication
(10) Pub. No.: US 2008/0053763 A1
(43) Pub. Date: Mar. 6, 2008

(54) System and method for self-powered magnetorheological-fluid damping

(76) Inventors: Norman Wereley, Potomac, MD (US); Young-Tai Choi, Laurel, MD (US)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/891,234

(22) Filed: Aug. 8, 2007

Related U.S. Application Data
(60) Provisional application No. 60/824,141, filed on Aug. 31, 2006.

(51) Int. Cl. F16F 9/53; F17D 3/00

(52) U.S. Cl. 188/267.2; 137/5

(57) ABSTRACT

A system and method for self-powered magnetorheological-fluid damping of mechanical vibrations includes a hydraulic cylinder. The hydraulic cylinder is configured for at least partially disposing magnetorheological fluid therein. A piston head is disposed within the hydraulic cylinder. The piston head has first and second sides and is configured to be in sliding engagement with the hydraulic cylinder. A piston rod is at least partially disposed within the hydraulic cylinder and is connected to the piston head on the first side. The system also includes a vibration absorber assembly having housing. The vibration absorber assembly is configured to transduce mechanical vibrations of the piston rod to electric current.

### PRIORITY CLAIM TO PROVISIONAL APPLICATION

This patent application claims priority to and the benefit of U.S. Provisional Patent Application No. 60/824,141, filed in the U.S. Patent and Trademark Office on Aug. 31, 2006, entitled “Self-Powered Magnetorheological Dampers”.

### BACKGROUND

1. Technical Field

The present disclosure relates to magnetorheological-fluid damping, and, in particular, to a system and method for self-powered magnetorheological-fluid damping of mechanical vibrations.

2. Description of Related Art

Generally, magnetorheological fluids (herein referred to as “MR” fluids) are a class of fluids that change in viscosity in the present of a magnetic field. An MR fluid may have the viscosity of commercially available motor oil when no magnetic field is present and may behave similarly to a solid when a magnetic field is applied (e.g., it may become a viscoelastic solid). Therefore, they exhibit controllable yield strength. When no magnetic field is present, MR fluids may be sufficiently modeled as Newtonian liquids. These unique properties make the material ideal for mechanical vibration damping because of the ability to utilize a magnetic field to control the apparent viscosity of an MR fluid. Additionally, an MR fluid may have a response time of less than 10 milliseconds making it well suited for mechanical vibration damping systems.

MR fluid dampers are emerging as a promising technology for semi-active actuator damping. They have been widely applied to control and suppress unwanted mechanical vibrations and shock of various systems and structures because of their inherent advantages. Such advantages include its ability to assist in continuously controlling force, its fast response, and its relatively small power consumption. Some mechanical vibration and shock mitigation systems that utilize MR fluid dampers include either a power supply and/or a current amplifier. Electrical current is inevitably necessary for activating electromagnetic coils (e.g., a stator) inside MR fluid dampers for providing a controllable magnetic field to affect the MR fluid. However, there has been a continuing need to reduce the electrical energy needed (e.g., electric current), to reduce the weight of the system, and to reduce the maintenance needed in any damping system including MR-fluid damping systems. Additionally, there has been a continuing need to the maintain cost-effectiveness of MR-fluid damping systems.

### SUMMARY

The present disclosure relates to magnetorheological-fluid damping, and, in particular, to a system and method for self-powered magnetorheological-fluid damping of mechanical vibrations.

In one aspect thereof, a magnetorheological-fluid damping system includes a hydraulic cylinder configured for at least partially disposing magnetorheological fluid therein. A piston head is disposed within the hydraulic cylinder and has first and second sides. The piston head is configured to be in sliding engagement with the hydraulic cylinder. A piston rod is at least partially disposed within the hydraulic cylinder and is connected to the piston head on the first side. The system also includes a vibration absorber assembly having a housing. The vibration absorber assembly is configured to transduce mechanical vibrations of the piston rod to electric current. A current amplifier may amplify the electric current transduced by the vibration absorber assembly. The vibration absorber assembly may be attached to the first side of the piston head, the hydraulic cylinder, or the piston rod.

The piston head may include a coil winding configured to convert the electric current to a magnetic field to affect the magnetorheological fluid. A floating piston may be disposed in the hydraulic cylinder forming a magnetorheological fluid chamber and a gas chamber. The floating piston is configured to maintain a predetermined pressure range of the pressure of the magnetorheological fluid as the piston rod slides through the hydraulic cylinder.

The magnetorheological-fluid damping system may be an installable module installable in an engine mount. Additionally or alternatively, the system may be utilized to dampen an engine and the vibration absorber assembly may have a predetermined resonance frequency from about 0 Hertz to about 100 Hertz.

In another aspect thereof, the vibration absorber assembly may be attached to the hydraulic cylinder and may include a magnet disposed within the housing. The magnet may be attached to the piston rod. The vibration absorber assembly may include a stator configured to receive the magnetic field of the magnet to transduce the mechanical vibrations of the piston rod to the electric current.

In another aspect thereof, the vibration absorber assembly may include a magnet, a stator and a spring. The magnet may form a hole and may be in sliding engagement with the piston rod. The piston rod may be positioned through the hole of the magnet. The stator may receive the magnetic field of the magnet to transduce to the mechanical vibrations of the piston rod to the electric current. Additionally or alternatively, the stator may be configured for receiving a changing magnetic field inducing the electric current. The spring includes first and second attachment points. The first attachment point may be attached to the housing and the second attachment point may be attached to the magnet.

In another aspect thereof, a method for dampening mechanical vibrations utilizing magnetorheological fluid is disclosed. The method includes providing a magnetorheological-fluid damping system, such as at least one of the systems mentioned supra, and dampening the mechanical vibrations. The mechanical vibrations may include at least one frequency constituent. Each frequency constituent has frequency and amplitude. Furthermore, the step of dampening the mechanical vibrations may include dampening a resonance frequency of an engine. Additionally or alternatively, the piston head may include a coil winding configured to convert the electric current to a magnetic field; the magnetic field being configured to affect the magnetorheological fluid. And the method may further include injecting the electric current into a coil winding.

In another aspect thereof, a magnetorheological-fluid damping system is disclosed including a means for utilizing magnetorheological fluid to dampen the movement of a piston head; the piston head is disposed with a hydraulic cylinder. The system includes a means for transducing mechanical vibrations to electric current within the hydraulic cylinder and a means for converting the electric current to a magnetic field. The magnetic field is configured to affect the magnetorheological fluid. The means for transducing mechanical vibrations to the electric current within the hydraulic cylinder may include a means for providing a changing magnetic field through a stator.

### BRIEF DESCRIPTION OF THE DRAWINGS

These and other advantages will become more apparent from the following detailed description of the various embodiments of the present disclosure with reference to the drawings wherein:

FIG. 1 is a schematic drawing of a cross-section view of an MR fluid damping system having a vibration absorber assembly attached to a piston head with a magnet in sliding engagement with a piston rod in accordance with the present disclosure;

FIG. 2 is a schematic drawing of a cross-section view of an MR fluid damping system having a vibration absorber assembly attached to a piston rod with a magnet in sliding engagement with the piston rod in accordance with the present disclosure;

FIG. 3 is a schematic drawing of a cross-section view of an MR fluid damping system having a vibration absorber assembly attached to a hydraulic cylinder with a magnet attached to a piston rod in accordance with the present disclosure;

FIG. 4 is a schematic drawing of an engine mounting system utilizing an MR fluid damping system to dampen an engine mass in accordance with the present disclosure.

### DETAILED DESCRIPTION

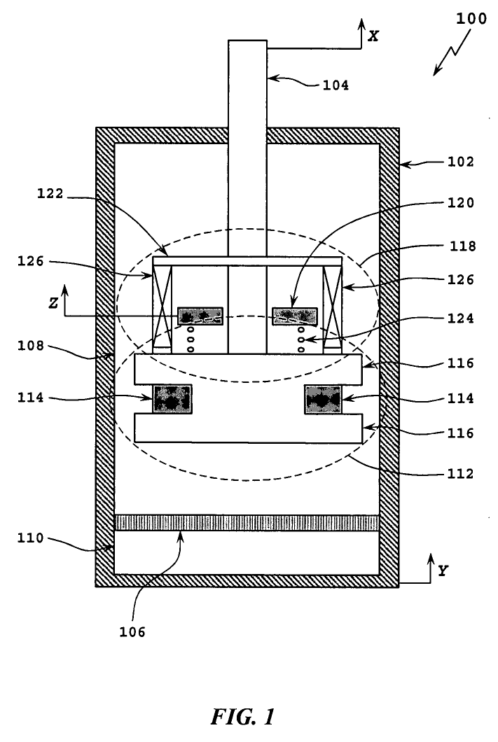

Referring to the drawings, simultaneously refer to FIGS. 1, 2, and 3 which depict a schematic diagram of an MR fluid damping system 100. MR fluid damping system 100 may be used to dampen engines, used in an engine mount, protect equipment, and/or may be used to dampen any other device from mechanical vibrations. For example, MR fluid damping system 100 may be used in a car to dampen the engine from the frame. Additionally or alternatively, MR fluid damping system 100 may be used in automobile “shocks” to dampen the mechanical vibrations coming from the tires to the passengers.

MR fluid damping system 100 may include a hydraulic cylinder 102 that houses fluid, e.g., MR fluid, air, oil, and/or other material, liquids or components. MR fluid system 100 may also include piston rod 104 in sliding in sliding engagement with hydraulic cylinder 102. The term “sliding engagement” is not intended to engagements in which the two items are touching, e.g., piston rod 104 may utilize one or more bearings so that piston rod 104 may slide in and out of hydraulic cylinder 102. Additionally or alternatively, bushings, bearings, rings, sealers, lubricants, gaskets and/or other technologies may be utilized in the sliding engagement of piston rod 104 with hydraulic cylinder 102.

Additionally, MR fluid damping system 100 may include floating piston 106. Floating piston 106 may divide hydraulic cylinder 102 into MR fluid chamber 108 and gas chamber 110. MR fluid chamber 108 may be wholly or partially filled with MR fluid, while gas chamber 110 may be wholly or partially filled with gas. Additionally or alternatively, a gasket and/or an O-ring may be positioned relative to floating piston 106 to prevent leakage between MR fluid chamber 108 and gas chamber 110.

Floating piston 106 may be configured such that a predetermined pressure range of the MR fluid chamber 108 is maintained for adequate operation of MR fluid damping system 100. For example, consider piston rod 104 moving out of hydraulic cylinder 102 reducing the aggregate volume of MR fluid chamber 108; this may cause the MR fluid to drop in pressure creating a “back pressure” impeding the outward movement of piston rod 104. Floating piston 106, in this example, may move toward MR fluid chamber 108 reducing the volume of MR fluid chamber 108 while increasing the volume of gas chamber 110, thus alleviating the “back pressure”. Floating piston 106 may operate reverse to the above example when piston rode 104 moves into hydraulic cylinder 102.

MR fluid damping system 100 may have piston rod 104 connected to piston head 112 as indicated by a circle approximating the general location of piston head 112 as shown in FIGS. 1, 2, and 3. Piston head 112 may have coil winding 114. Coil winding 114 may be configured to create a magnetic field (not depicted) that affects the magnetorheological fluid. For example, in the situation where coil winding 114 creates no magnetic field (or minimal magnetic field), the MR fluid surrounding piston head 112 may behave as if the it were surrounded by a low viscosity liquid, allowing piston head 112 and piston rod 104 to move up and down with little resistance. However, note that as the apparent viscosity of the fluid increases the more “damped” the movement of head 112 (thus piston rod 104) becomes because of the difficulty the MR fluid has to move around piston head 112. Therefore, by increasing the magnetic field created by coil winding 114, the MR fluid becomes more viscous resulting in a more “damped” movement of piston head 112 when moving throughout hydraulic cylinder 102. Thus, by utilizing coil winding 114 to control a magnetic field configured to affect the MR fluid, it is possible to control the damping of MR fluid damping system 100. Coil winding 114 may create the magnetic field by running an electric current through the wires. The relationship between electricity and magnetism is well known.

Coil winding 114 may form a solenoid configuration and also may utilize a “soft” ferromagnetic material to enhance and/or shape the magnetic field. Also, a permanent magnet (not shown), such as a rare earth magnet, may be positioned to increase the magnetic field acting of the MR fluid. Additionally or alternatively, the relevant active poles may be positioned anywhere to suitably affect the MR fluid; however, actives poles 116 are depicted.

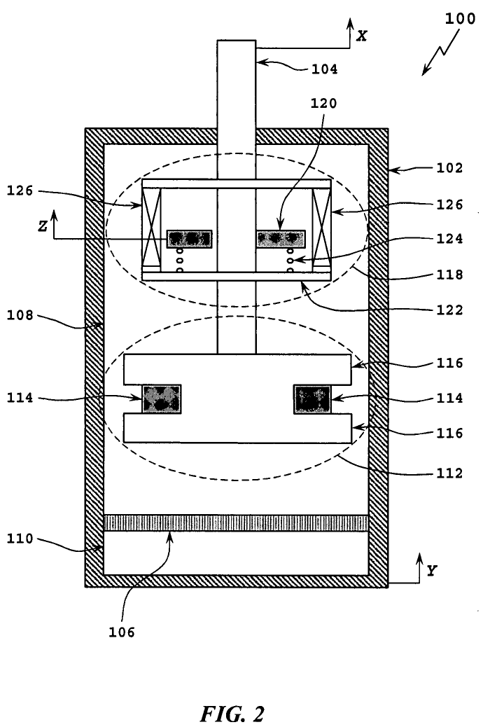

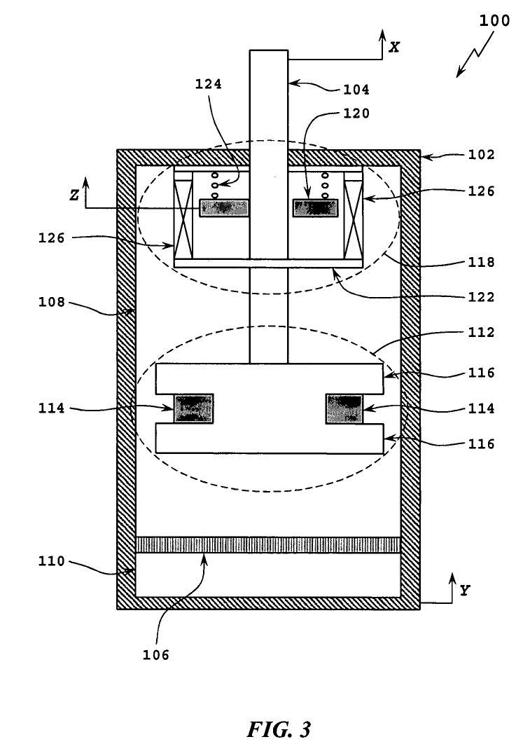

The electric current that activates coil winding 114 may be generated and/or created by vibration absorber assembly 118 (herein referred to as “VAA 118”). VAA 118 may include magnet 120 disposed inside housing 122. Housing 122 may prevent fluid (e.g., MR fluid) and/or gas from entering into VAA 118. Additionally or alternatively, housing 122 may prevent fluid (e.g., oil) and/or air from escaping from within VAA 118. Magnet 120 may be circular and may form a hole. Piston rod 104 may be positioned within that hole. Note that in FIGS. 1 and 2, magnet 120 is in sliding engagement with piston rode 104, while in FIG. 3 it is attached to piston rod 104.

Magnet 120 may be attached to housing 122 via spring 124. As mechanical vibrations reach VAA 118 magnet 120 may freely move up and down relative to piston head 112. Additionally, in the embodiments depicted in FIGS. 1 and 2, magnet 120 may move up and down relative to piston rod 104. However, in FIG. 3, magnet 120 is attached to piston rod 104, thus moving with piston rod 104, while housing 122 remains stationary relative to hydraulic cylinder 102. However, some of Equations 1 through 11b may not apply to FIG. 3 because the movement of magnet 120 follows piston rod 104. Regardless of the embodiment, magnet 120 is configured within VAA 118 to move relative to stator 126.

The magnetic field of magnet 120 may sweep across stator 126 when magnet 120 moves inducing electric current. This arrangement may cause VAA 118 to transduce mechanical vibrations to electric current. The term “transduce” is defined herein as “converting one form of energy to another”, the verb “transducing” is the act of “converting one form of energy to another”, and the term transduced is an adjective used to refer to “a form of energy that has been converted from one form of energy to the present form”. The mechanical vibrations may come from piston rod 104 and/or from hydraulic cylinder 102. This electric current generated by VAA 118 may be used to generate a magnetic field via utilizing coil winding 114. This may be accomplished by connecting the positive and negative terminals of stator 126 to the positive and negative terminals of coil winding 114 (terminals not shown). Additionally or alternatively, VAA 118 may be “tuned” to absorb different mechanical vibrations according to its frequency, polarization, and/or direct of travel.

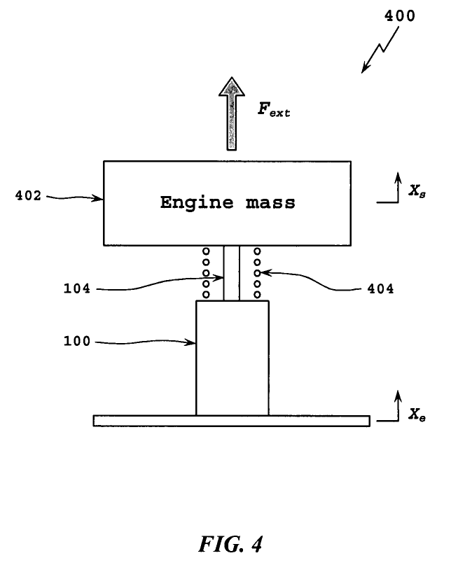

In the embodiments shown in FIGS. 1 and 2, magnet 120 may show relative motion to piston head 112 and piston rod 104. The movement of magnet 120 due to piston rod 104 may generate electromotive force (referred to herein as “emf”) in stator 126 and the strength of the emf is proportional to the motion speed of magnet 120. The emf (induced voltage or current) may be directly provided to activate coil winding 114 in piston head 112 so as to produce a magnetic field into the MR fluid inside hydraulic cylinder 102. Additionally or alternatively, VAA 118 may itself operate as a mechanical vibration absorber since it is similar to a single degree of freedom mass-spring-damping system. If the resonance frequency of the VAA 118 is matched to that of a target system to be damped (e.g., engine mass 402 in FIG. 4, discussed infra), the movement of magnet 120 will be greatly larger than the input excitation motion.

The emf value of E_{emf}, that is generated by the motion of magnet 120 in VAA 118 is given by Equation (1) as:

$${E}_{emf} = - {N}_{m} \frac{d Φ}{d t} = - {N}_{m} α {B}_{m} 2 π {r}_{m} ( {z}^{*} - {x}^{*} ) \qquad ( 1 )$$

Here, Nₘ is the turn number of the coil in stator 126 affected by magnet 120 at a time, Φ is the magnetic flux, Bₘ is the magnetic density of the magnet 120, rₘ is the radius of the magnet 120, \dot{x} is the velocity of piston rod 104, and ż is the velocity of magnet 120. α is the empirical correction factor for the effective magnetic density of magnet 120 since there is a gap clearance between magnet 120 and stator 126. For example, the values may be as follows: Nₘ=120 turns, α=0.75, Bₘ=1.2T, and rₘ=15 mm. The current I of coil winding 114 due to the emf is given by Equation (2) as follows:

$$I = \frac{{E}_{emf}}{{R}_{s} + {R}_{c}} \qquad ( 2 )$$

Here, Rₛ is the resistance of stator 126 and R_{c} is the resistance of coil winding 114, for example: Rₛ+R_{c}=3Ω. The forces associated with MR fluid damping system 100 may be given by Equation (3) as follows:

F_{d}=Fₚₐₛₛᵢᵥₑ+Fₛₑₘᵢ+F_{gas} (3)

where

$$\begin{matrix}{F}_{passive} = {A}_{p}^{2} ( \frac{6 η L}{π {rd}^{3}} + \frac{6 η {L}_{c}}{π {r}_{c} {d}_{c}^{3}} + \frac{6 η {L}_{s}}{π {r}_{s} {d}_{s}^{3}} ) ( {x}^{*} - {y}^{*} ) + ( \frac{2 ηπ rL}{d} + \frac{2 ηπ {r}_{c} {L}_{c}}{{d}_{c}} + \frac{2 ηπ {r}_{s} {L}_{s}}{{d}_{s}} ) ( {x}^{*} - {y}^{*} ) , & ( 4 ) \\ {F}_{semi} = ( 2 {A}_{p} \frac{L}{d} + 2 π rL ) {τ}_{y} ( H ) sgn ( {x}^{*} - {y}^{*} ) , & ( 5 )\end{matrix}$$

and

F_{gas}=K_{gas}(x−y) (6)

Here, Aₚ is the effective piston area of piston head 112, Aᵣ is the area of piston rod 104, and y is the displacement of hydraulic cylinder 102. d, d_{c}, and dₛ are the gap of active pole 116, coil winding 114, and stator 126, respectively. r, r_{c}, and rₛ are the radius of active pole 116, coil winding 114, and stator 126, respectively. L, L_{c}, and Lₛ are the length of active pole 116, coil winding 114, and stator 126, respectively. η is the fluid viscosity of the MR fluid within hydraulic cylinder 102, and τ_{y}(H) is the yield shear stress of an MR fluid and is assumed to be a function of the magnetic field strength H as illustrated in the following equations:

τ_{y}(H)=0.93H^{1.73}[Pa] (7)

where

$$H = \vert \frac{{N}_{c} I}{2 d} \vert [ A \text{/} mm ] . \qquad ( 8 )$$

N_{c} is the turn number of coil winding 114 in piston head 112. K_{gas} is the stiffness due to the gas pressure in gas chamber 110 and is given by Equation (9) as follows:

$${K}_{gas} = \frac{{nA}_{r}^{2} {P}_{0}}{{V}_{0}} . \qquad ( 9 )$$

n is the specific heat ratio of the gas in gas chamber 110, and P₀ and V₀ are the initial pressure and volume of gas chamber 110, respectively. For example, consider the following: Aₚ=1700 mm², Aᵣ=79 mm², L=20 mm, L_{c}=15 mm, Lₛ=30 mm, r=24 mm, r_{c}=21 mm, rₛ=21 mm, d=1 mm, d_{c}=4 mm, dₛ=4 mm, η=0.18 Pa·s, and N_{c}=150

To model and/or predicts differing force responses of MR fluid damping system 100, consider a time response of the semi-active damper force, Fₛₑₘᵢ as follows:

$${{{F}^{*}}_{semi}}^{*} = \frac{- {F}_{semi}^{*} + {F}_{semi}}{τ} . \qquad ( 10 )$$

Here, F*ₛₑₘᵢ is an emulated semi-active damper force and r is the time response of MR fluid damping system 100. In this example, it was chosen to be τ=5 msec. For example, during a computer simulation, the semi-active damper force, Fₛₑₘᵢ will be replaced by an emulated semi-active damper force, F*ₛₑₘᵢ.

Referring now to the drawings, FIG. 4 depicts an engine mounting system 400 that includes an engine mass 402, engine mass 402 may be a mass created by an engine, and/or any other source of mechanical vibrations and/or mass. Additionally MR fluid damping system 100 is shown as supporting engine mass 402 with coil spring 404. Piston rod 104 is shown as connecting MR fluid damping system 100 to engine mass 402. Coil spring 404 may provide force on engine mass 402, e.g., to help support the weight of engine mass 402.

The governing equation of motion for engine mounting system 400 using MR fluid damping system 100 is illustrated by Equations (11a) and (11b) as follows:

$${M}_{s} {{x}^{**}}_{s} = - ( {K}_{s} + {K}_{gas} ) ( {x}_{s} - {x}_{e} ) - {F}_{passive} - {F}_{semi}^{*} + {K}_{a} ( {x}_{a} - {x}_{s} ) + {C}_{a} ( {{x}^{*}}_{a} - {{x}^{*}}_{s} ) + {F}_{ext} , \qquad ( 11 a )$$

and

Mₐ\ddot{x}ₐ=Kₐ(xₐ−xₛ)−Cₐ(\dot{x}ₐ−\dot{x}ₛ) (11b)

Mₛ is the mass of engine mass 402, Mₐ is the mass of magnet 120 in MR fluid damping system 100, Fₑₓₜ is the external shock force, Kₛ is the stiffness of the coil spring 404, Kₐ and Cₐ are the stiffness and the damping of spring 124 in MR fluid damping system 100, respectively. xₛ is the displacement of the engine mass 402, xₐ is the displacement of magnet 120, and xₑ is the excitation displacement. For example, the values may be as follows: Mₛ=60 kg, Mₐ=0.4 kg, Kₛ+K_{gas}=150 kN/m, and Cₐ=4 N·s/m.

In some environments, the vibration isolation performance of a vibration isolation system is designed so that there is higher damping around a resonance frequency and lower damping above the resonance frequency. In these environments, an MR fluid damping system 100 may be turned “on” around the resonance frequency and turned “off” above the resonance frequency to provide effective performance. However, VAA 118 may be analogized and/or modeled as a “spring-mass” system having a resonance frequency; thus, spring 124 of VAA 118 may have larger displacements around the “resonance frequency” of VAA 118. Frequencies higher than the resonance frequency of VAA 118 causes the displacements of magnet 120 to become smaller than the displacements experienced around the resonance frequency. This behavior causes MR fluid damping system 100 to produce high damping around the resonance frequency of VAA 118 and low damping above the resonance frequency of VAA 118. Note that MR fluid damping system 100 does not utilize any sensors, microprocessors, control inputs, and/or control algorithms; however, it is envisioned that one of ordinary skill in the relevant art will appreciate their use in appropriate applications and/or environments.

Referring again to FIG. 4, an example resonance frequency of engine mounting system 400 may be 8.0 Hz; therefore, an initial choice for the stiffness of VAA 118 is theorized to be Kₐ=1000 N/m to match the resonance frequency of VAA 118 with that of engine mounting system 400. However, in order to find an optimal stiffness, the maximum peak value of the transmissibility, |xₛ/xₑ|, of the engine mounting system vs. the stiffness of VAA 118 in MR fluid damping system 100 may be calculated. From this calculation, the optimal stiffness value of VAA 118 for engine mounting system 400 is Kₐ=700 N/m. This optimal stiffness, Kₐ=700 N/m, utilizes a resonance frequency of VAA 118 slightly lower than that of the engine mounting system 400. The optimal stiffness, Kₐ=700 N/m, of VAA 118 for engine mounting system 400 may be used to evaluate the vibration isolation capability of MR fluid damping system 100.

Accordingly, it will be understood that various modifications may be made to the embodiments disclosed herein, and that the above descriptions should not be construed as limiting, but merely as illustrative of preferred embodiments. Those skilled in the art will envision other modifications within the scope and spirit of the claims appended hereto.

What we claim is:

1. A magnetorheological-fluid damping system, comprising:
a hydraulic cylinder configured for at least partially disposing magnetorheological fluid therein;
a piston head disposed within the hydraulic cylinder, the piston head having first and second sides, wherein the piston head is configured to be in sliding engagement with the hydraulic cylinder;
a piston rod at least partially disposed within the hydraulic cylinder, wherein the piston rod is connected to the piston head on the first side; and
a vibration absorber assembly having a housing, the vibration absorber assembly being configured to transduce mechanical vibrations of the piston rod to electric current.

2. The system according to claim 1, wherein the vibration absorber assembly is attached to the hydraulic cylinder.

3. The system according to claim 2, wherein the vibration absorber assembly comprises:
a magnet disposed within the housing, the magnet being attached to the piston rod.

4. The system according to claim 3, wherein the vibration absorber assembly further comprises:
a stator configured to receive the magnetic field of the magnet to transduce the mechanical vibrations of the piston rod to the electric current.

5. The system according to claim 1, wherein the vibration absorber assembly is operatively connected to the first side of the piston head.

6. The system according to claim 1, wherein the vibration absorber assembly is operatively connected to the piston rod.

7. The system according to claim 1, wherein the vibration absorber assembly comprises:
a magnet forming a hole, wherein the magnet is configured to be in sliding engagement with the piston rod, wherein the piston rod is position through the hole of the magnet.

8. The system according to claim 7, wherein the vibration absorber assembly further comprises:
a stator configured to receive the magnetic field of the magnet to transduce to the mechanical vibrations of the piston rod to the electric current.

9. The system according to claim 7, wherein the vibration assembly further comprises:
a spring having first and second attachment points, wherein the first attachment point is attached to the housing and the second attachment point is attached to the magnet.

10. The system according to claim 1, wherein the vibration absorber assembly comprises:
a stator configured for receiving a changing magnetic field, wherein the changing magnet field induces the electric current.

11. The system according to claim 1, wherein the piston head comprises:
a coil winding configured to convert the electric current to a magnetic field, the magnetic field being configured to affect the magnetorheological fluid.

12. The system according to claim 1, further comprising:
a floating piston disposed in the hydraulic cylinder forming a magnetorheological fluid chamber and a gas chamber, wherein the floating piston is configured to maintain a predetermined pressure range of the pressure of the magnetorheological fluid as the piston rod slides through the hydraulic cylinder.

13. The system according to claim 1, wherein the system is configured to be an installable module installable in an engine mount.

14. The system according to claim 1, wherein the system is utilized to dampen an engine, wherein the vibration absorber assembly is configured to have a predetermined resonance frequency from about 0 Hertz to about 100 Hertz.

15. The system according to claim 1, further comprising:
a current amplifier configured to amplify the electric current transduced by the vibration absorber assembly.

16. A method for dampening mechanical vibrations utilizing magnetorheological fluid, comprising:
providing a magnetorheological-fluid damping system, comprising:
a hydraulic cylinder configured for at least partially disposing magnetorheological fluid therein;
a piston head disposed within the hydraulic cylinder, the piston head having first and second sides, wherein the piston head is configured to be in sliding engagement with the hydraulic cylinder;
a piston rod at least partially disposed within the hydraulic cylinder, wherein the piston rod is connected to the piston head on the first side; and
a vibration absorber assembly having a housing, the vibration absorber assembly being configured to transduce mechanical vibrations of the piston rod to electric current; and
dampening the mechanical vibrations, wherein the mechanical vibrations include at least one frequency constituent.

17. The method according to claim 16, wherein the step of dampening the mechanical vibrations comprises:
dampening a resonance frequency of an engine.

18. The method according to claim 16, wherein the piston head further comprises a coil winding configured to convert the electric current to a magnetic field, the magnetic field being configured to affect the magnetorheological fluid, wherein the method further comprises:
injecting the electric current into a coil winding.

19. A magnetorheological-fluid damping system, comprising:
means for utilizing magnetorheological fluid to dampen the movement of a piston head, wherein the piston head is disposed with a hydraulic cylinder; and
means for transducing mechanical vibrations to electric current within the hydraulic cylinder; and
means for converting the electric current to a magnetic field, the magnetic field being configured to affect the magnetorheological fluid.

20. The system of claim 19, wherein the means for transducing mechanical vibrations to the electric current within the hydraulic cylinder further comprising:
means for providing a changing magnetic field through a stator.
